(19) United States
(12) Patent Application Publication
(10) Pub. No.: US 2009/0102676 A1
(43) Pub. Date: Apr. 23, 2009

(54) CONTEXT-RELATIVE REMINDERS

(75) Inventors: Gary Hoffmann, Aurora, CO (US); Ian M. Lotinsky, Montgomery Village, MD (US); Lori A. Machules, Oviedo, FL (US)

Correspondence Address: PRASS LLP, 2661 Riva Road, Bldg. 1000, Suite 1044, ANNAPOLIS, MD, 21401, US

(73) Assignee: LOCKHEED MARTIN CORPORATION, Bethesda, MD (US)

(21) Appl. No.: 11/876,284

(22) Filed: Oct. 22, 2007

(51) Int. Cl. G08B 21/00

(52) U.S. Cl. 340/686.6

(57) ABSTRACT

A method and apparatus that presents context-relative reminders to a user of a portable electronic device is disclosed. The method may include receiving reminder inputs relating to a reminder. The reminder may become active upon predetermined criteria being met. The predetermined criteria may be at least two of position, time, movement, proximity to designated people, and proximity to designated objects. The method may then include determining whether the predetermined criteria have been met. If the predetermined criteria have been met, the method may include presenting the reminder to the user.

### BACKGROUND OF THE DISCLOSURE

1. Field of the Disclosure

This disclosure relates to reminders sent to users of electronic devices.

2. Introduction

Often tasks are associated with time when they really are context-sensitive. In particular, the tasks involve certain physical locations, people, etc. People typically predict where they will be at certain times and associate these context-sensitive tasks with the other parameters. However, people are not always able to predict accurately, issues come up, plans change, etc. What results are reminders that come too early, too late, or may be never come, thus defeating their whole purpose.

### SUMMARY OF THE DISCLOSURE

A method and apparatus that presents context-relative reminders to a user of a portable electronic device is disclosed. The method may include receiving reminder inputs relating to a reminder. The reminder may become active upon predetermined criteria being met. The predetermined criteria may be at least two of position, time, movement, proximity to designated people, and proximity to designated objects. The method may then include determining whether the predetermined criteria have been met. If the predetermined criteria have been met, the method may include presenting the reminder to the user.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary diagram of a network environment in accordance with a possible embodiment of the disclosure;

FIG. 2 illustrates a block diagram of an exemplary portable electronic device in accordance with a possible embodiment of the disclosure; and

FIG. 3 is an exemplary flowchart illustrating one possible context-relative reminder process in accordance with one possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure. This disclosure concerns a context-relative reminder system is to remind people of context-sensitive tasks when they are in the appropriate contexts. Reminders may exist as notes or tasks and are may be mapped to one or more contexts: For example:

Time—May perform like current reminder systems with the ability to specify a time frame (an end time for the reminder).

Locations—The system may integrate a digital map (Internet-based, cached, or both) equipped with context-awareness. Context-awareness may be powered by GPS latitude, longitude, and altitude), with fallback to cell-tower triangulation or, worst case, manual user input. Locations may be established as zones. Zones may be any two or three dimension shape, including circular, square/rectangle, polygonal, and vector-based paths.

People and Objects
Such as RFID, Bluetooth, or other wirelessly-enabled devices.
Other context-relative-aware systems and devices.

An example of a complex reminder may concern meeting with a specific individual at a specific location within a specific time-frame.

In one example of the embodiments described herein, a user may enter reminder inputs (context) for a task, such as location, people, time to be completed by, etc. He or she may know that the task needs to be performed the same day, week, etc. but with no specific time. However, if the user enters the approximate a location where the task may be completed, a reminder with pop up on the user's portable electronic device. If the task involved a person or an object, the reminder may pop up when in proximity of the user and/or the user's portable electronic device.

Reminders may also become active and display to a user when the user travels a particular path, road, etc. In this manner, if a user is moving along a particular road; for example, a reminder may be set up not to speed due to a speed trap, slick roads, etc.

The embodiments discussed herein may also utilize a collaborative server or computer. A collaborative server may broadcast reminders to a specific set of remote reminder systems, present the context of devices to each of the reminder systems, as well as coordinate privileges.

For example, if a user is trying to coordinate teams of people such as at a disaster site, and the user may wish to coordinate information so that everyone involved may be aware or certain hazards, events, activities, etc. For example, if the user knows that a certain elevator is broken and that people should not use it, or that there is a water main break that might pose a danger, the user may create regions for those areas, and so individual's PDAs synch up through the server such that if an individual crosses into that region or somewhere close to the region, a notice reminder is posted warning the individual of the hazard, event, etc. Thus, the use of a centralized reminder server, computer, etc., may coordinate between PDAs and serve as a central way to store data concerning reminders.

Note that the embodiments concerning the context-relative reminders may exist as an isolated system as well as an extension to current reminder systems, for example.

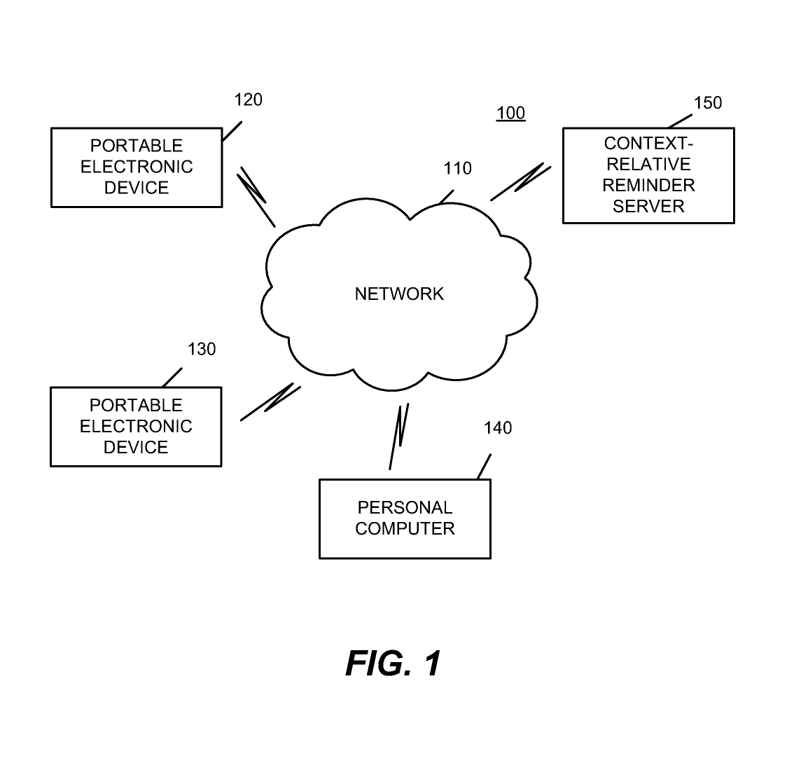

FIG. 1 illustrates an exemplary diagram of a network environment 100 in accordance with a possible embodiment of the disclosure. In particular, the communications system may include portable electronic devices 120, 130, personal computer 140, and server 150 connected through network 110.

Network 110 may represent any possible communications network, including wireless telephone networks, hardwired telephone networks, wireless local area networks (WLAN), the Internet, an intranet, etc.

The portable electronic device 120, 130 may be a portable MP3 player, satellite radio receiver, AM/FM radio receiver, satellite television, portable music player, portable computer, wireless radio, wireless telephone, portable digital video recorder, cellular telephone, mobile telephone, personal digital assistant (PDA), etc., or combinations of the above, for example.

The personal computer 140 and server 150 may represent any computer, server, etc. able to send communications to other computers, servers, portable electronic devices 120, 130, etc.

In the context of this disclosure, the portable electronic device 120 may receive reminders set by the device itself, the user using the device itself, or via network 110 from remote locations such as from another portable electronic device 130, a personal computer 140, a server 150, or other device. In other works, the reminder inputs may be received from electronic devices other than the user's portable electronic device. The other electronic device may be a portable MP3 player, a satellite radio receiver, a AM/FM radio receiver, a satellite television, a portable music player, a portable computer, a wireless radio, a wireless telephone, a portable digital video recorder, a cellular telephone, a mobile telephone, a personal computer, a server, a personal digital assistant (PDA), etc., or combinations of the above, for example.

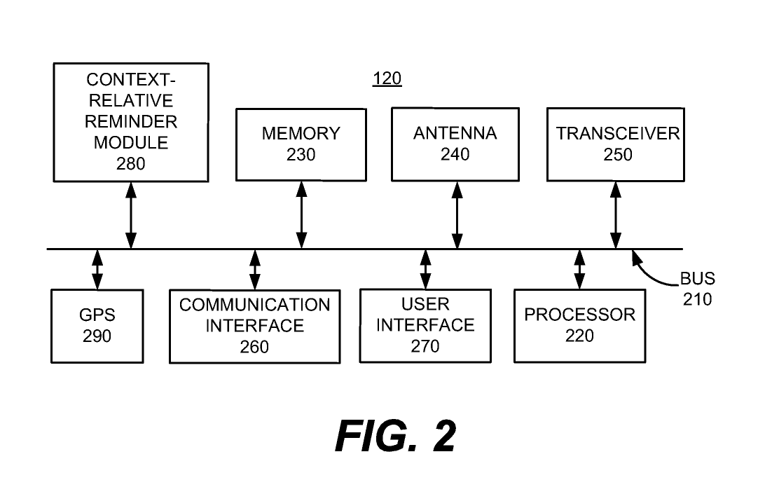

FIG. 2 illustrates a block diagram of an exemplary portable electronic device 120 in accordance with a possible embodiment of the invention. The portable electronic device 120 may include a bus 210, a processor 220, a memory 230, an antenna 240, a transceiver 250, a communication interface 260, a user interface 270, a context-relative reminder module 280, and a Global Positioning System (GPS) 290. Bus 210 may permit communication among the components of the portable electronic device 120.

Processor 220 may include at least one conventional processor or microprocessor that interprets and executes instructions. Memory 230 may be a random access memory (RAM or another type of dynamic storage device that stores information and instructions for execution by processor 220. Memory 230 may also include a read-only memory (ROM which may include a conventional ROM device or another type of static storage device that stores static information and instructions for processor 220.

Transceiver 250 may include one or more transmitters and receivers. The transceiver 250 may include sufficient functionality to interface with any network or communications station and may be defined by hardware or software in any manner known to one of skill in the art. The processor 220 is cooperatively operable with the transceiver 250 to support operations within the network 110. The transceiver 250 transmits and receives transmissions via one or more of the antennae 240 in a manner known to those of skill in the art.

Communication interface 260 may include any mechanism that facilitates communication via the network 110. For example, communication interface 260 may include a modem. Alternatively, communication interface 260 may include other mechanisms for assisting the transceiver 250 in communicating with other devices and/or systems via wireless connections.

User interface 270 may include one or more conventional input mechanisms that permit a user to input information, communicate with the portable electronic device 110, and/or present information to the user, such as a an electronic display, microphone, touchpad, keypad, keyboard, mouse, pen, stylus, voice recognition device, buttons, one or more speakers, etc. For example, the user interface 270 may receive reminder information and/or signals from the context-relative reminder module 280 to a present a reminder to the user using the display, speakers, etc.

GPS 290 may represent any known or future-developed combination of positioning systems that may be used to track the location of the portable electronic device 120. The GPS 290 may communicate information concerning position to the context-relative reminder module 280 so that the context-relative reminder module 280 may know the position criteria to activate particular reminders for presentation to the user. The GPS 290 may also assist in the determination of other parameters that may trigger reminders, such as the user's velocity, acceleration, etc.

The portable electronic device 120 may perform such functions in response to processor 220 and/or context-relative reminder module 280 by executing sequences of instructions contained in a computer-readable medium, such as, for example, memory 230. Such instructions may be read into memory 230 from another computer-readable medium, such as a storage device or from a separate device via communication interface 260.

For illustrative purposes, the exemplary operation of the context-relative reminder module 280 and the context-relative reminder process will be described below in relation to the diagrams shown in FIGS. 1-2.

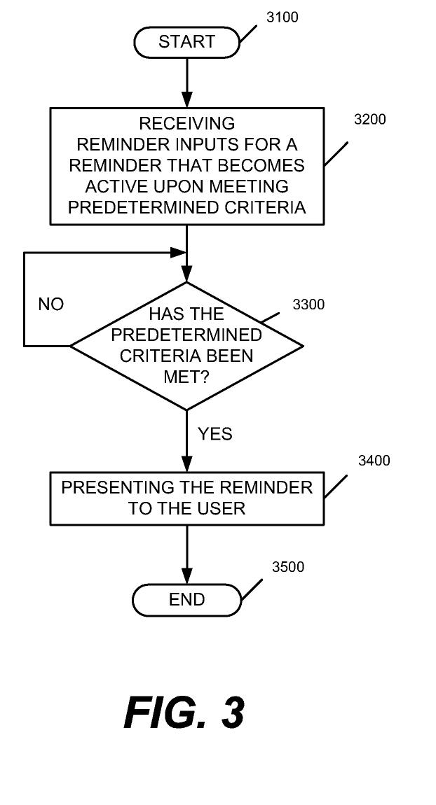

FIG. 3 is an exemplary flowchart illustrating one possible context-relative reminder process in accordance with one possible embodiment of the disclosure. The process begins at step 3100 and continues to step 3200 where the context-relative reminder module 280 may receive reminder inputs relating to a reminder. The reminder inputs may be a location, a time, one or more people, and one or more event, etc. The reminder may become active upon predetermined criteria being met.

The predetermined criteria may be at least two of position, time, movement, proximity to designated people, and proximity to designated objects. Movement may be direction, altitude, speed, acceleration, etc. The designated objects may be a Radio Frequency Identification (RFID) device, a wirelessly-enabled device, and a Bluetooth device.

At step 3300, the context-relative reminder module 280 may determine whether the predetermined criteria have been met. If the predetermined criteria have been met, at step 3400, the user interface 270 presents the reminder to the user. The process then goes to step 3500 and ends.

Note that the context-relative reminder module 280 may prioritize the reminders according to the predetermined criteria. In this manner, if the context-relative reminder module 280 detects a certain series of contexts that the user is within, it may choose to show one reminder first before another. Once that reminder has been addressed by the user (accepted, marked as completed, dismissed, etc.), the context-relative reminder module 280 may display the next prioritized reminder. The context-relative reminder module 280 may also specify why a reminder could not be completed and may adjust those contexts for the future.

For example, if the user has a reminder to go to the post office and then happens to be driving home and the context-relative reminder module 280 is notified by the GPS that he or she is approaching a post office, for example. Once near the post office, the context-relative reminder module 280 may recognize a user or automatically generated rule that at that particular time the post office very busy. Thus, there may be a series of rules created such that the context-relative reminder module 280 can automatically adjust the context based upon user feedback as to why he or she is rejecting the reminder.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the context-relative reminder module 280 in FIG. 2 each processing the content in various possible ways. It does not necessarily need to be one system used by all end users. Accordingly, the appended claims and their legal equivalents should only define the disclosure, rather than any specific examples given.

We claim:

1. A method for presenting context-relative reminders to a user of a portable electronic device, comprising:
receiving reminder inputs relating to a reminder, wherein the reminder becomes active upon predetermined criteria being met, the predetermined criteria being at least two of position, time, movement, proximity to designated people, and proximity to designated objects;
determining whether the predetermined criteria have been met, wherein if the predetermined criteria have been met,
presenting the reminder to the user.

2. The method of claim 1, wherein movement is at least one of direction, altitude, speed, and acceleration.

3. The method of claim 1, wherein the reminder inputs are a location and at least one of a time, one or more people, and one or more event.

4. The method of claim 1, wherein the reminders are prioritized according to the predetermined criteria.

5. The method of claim 1, wherein the reminder inputs are received from a electronic device other than the user's portable electronic device, wherein the other electronic device may be a portable MP3 player, a satellite radio receiver, a AM/FM radio receiver, a satellite television, a portable music player, a portable computer, a wireless radio, a wireless telephone, a portable digital video recorder, a cellular telephone, a mobile telephone, a personal computer, a server, and a personal digital assistant PDA).

6. The method of claim 1, wherein the designated objects are at least one of a Radio Frequency Identification (RFID) device, a wirelessly-enabled device, and a Bluetooth device.

7. The method of claim 1, wherein the portable electronic device is one of a portable MP3 player, satellite radio receiver, AM/FM radio receiver, satellite television, portable music player, portable computer, wireless radio, wireless telephone, portable digital video recorder, cellular telephone, mobile telephone, and personal digital assistant (PDA).

8. A portable electronic device that presents context-relative reminders to a user, the instructions comprising:
a context-relative reminder module that receives reminder inputs relating to a reminder, wherein the reminder becomes active upon predetermined criteria being met, the predetermined criteria being at least two of position, time, movement, proximity to designated people, and proximity to designated objects, and determines whether the predetermined criteria have been met; and
a user interface that presents the reminder to the user if the predetermined criteria have been met.

9. The portable electronic device of claim 8, wherein movement is at least one of direction, altitude, speed, and acceleration.

10. The portable electronic device of claim 8, wherein the reminder inputs are a location and at least one of a time, one or more people, and one or more event.

11. The portable electronic device of claim 8, wherein the context-relative reminder module prioritizes the reminders according to the predetermined criteria.

12. The portable electronic device of claim 8, wherein portable electronic device receives the reminder inputs from one of a portable MP3 player, a satellite radio receiver, a AM/FM radio receiver, a satellite television, a portable music player, a portable computer, a wireless radio, a wireless telephone, a portable digital video recorder, a cellular telephone, a mobile telephone, a personal computer, a server, and a personal digital assistant (PDA).

13. The portable electronic device of claim 8, wherein the designated objects are at least one of a Radio Frequency Identification (RFID) device, a wirelessly-enabled device, and a Bluetooth device.

14. The portable electronic device of claim 8, wherein the portable electronic device is one of a portable MP3 player, satellite radio receiver, AM/FM radio receiver, satellite television, portable music player, portable computer, wireless radio, wireless telephone, portable digital video recorder, cellular telephone, mobile telephone, and personal digital assistant (PDA).

15. A computer readable medium that stores instructions for presenting context-relative reminders to a user of a portable electronic device, the instructions comprising:
receiving reminder inputs relating to a reminder, wherein the reminder becomes active upon predetermined criteria being met, the predetermined criteria being at least two of position, time, movement, proximity to designated people, and proximity to designated objects;
determining whether the predetermined criteria have been met, wherein if the predetermined criteria have been met,
presenting the reminder to the user.

16. The computer readable medium of claim 15, wherein movement is at least one of direction, altitude, speed, and acceleration, and the designated objects are at least one of a Radio Frequency Identification (RFID) device, a wirelessly-enabled device, and a Bluetooth device.

17. The computer readable medium of claim 15, wherein the reminder inputs are a location and at least one of a time, one or more people, and one or more event.

18. The computer readable medium of claim 15, wherein the reminders are prioritized according to the predetermined criteria.

19. The computer readable medium of claim 15, wherein the reminder inputs are received from an electronic device other than the user's portable electronic device, wherein the other electronic device may be a portable MP3 player, a satellite radio receiver, a AM/FM radio receiver, a satellite television, a portable music player, a portable computer, a wireless radio, a wireless telephone, a portable digital video recorder, a cellular telephone, a mobile telephone, a personal computer, a server, and a personal digital assistant PDA).

20. The computer readable medium of claim 15, wherein the portable electronic device is one of a portable MP3 player, satellite radio receiver, AM/FM radio receiver, satellite television, portable music player, portable computer, wireless radio, wireless telephone, portable digital video recorder, cellular telephone, mobile telephone, and personal digital assistant PDA).
